(19) United States
(12) Patent Application Publication
(10) Pub. No.: US 2026/0039531 A1
(43) Pub. Date: Feb. 5, 2026

(54) MIMO-OTFS TRANSMISSION AND RECEPTION FOR NEXT GENERATION WLAN COMMUNICATION SYSTEMS

(71) Applicant: INDIAN INSTITUTE OF TECHNOLOGY KHARAGPUR, Kharagpur (IN)

(72) Inventors: Chaithanya Velampalli, Kharagpur (IN); B. V. Sudhakar Reddy, Kharagpur (IN); Suvra Sekhar Das, Kharagpur (IN)

(21) Appl. No.: 18/968,114

(22) Filed: Dec. 4, 2024

(30) Foreign Application Priority Data
Aug. 5, 2024 (IN) 202431059214

(51) Int. Cl. H04L 27/26; H04B 7/0456; H04L 1/00

(52) U.S. Cl. CPC H04L 27/26532; H04B 7/0456; H04L 1/0061

(57) ABSTRACT

The present invention discloses a Orthogonal Time Frequency Space (OTFS) based communication system for Wireless Local Area Network (WLAN) involving Multiple Input Multiple Output (MIMO) channels comprising a transmitter including LDPC FEC (Forward Error Correction) encoder for input bit stream appended with pre-FEC bit sequence and transmission of LDPC encoded input data stream adapted for OTFS demodulation with the compatible receiver through multiple antennas with (Multiple Input Multiple Output) MIMO pre-coding, signal processor means including OTFS modulators and a receiver with multiple antennas compatible to said transmitter and signal processor means for said OTFS waveform based transmission and retrieving of the input data stream.

### FIELD OF THE INVENTION

The present invention relates to Orthogonal Time Frequency Space (OTFS) based communication standard for wireless local area networks (WLAN). More specifically, the present invention is directed to a communication system involving transmitter supporting OTFS modulation and multi-stream transmission with LDPC (Low density Parity Check) coding for WLAN and receiver compatible to transmission methodology of the transmitter.

### BACKGROUND OF THE INVENTION

Wi-Fi is a family of standards developed by Institute of Electrical and Electronic Engineers (IEEE) for wireless local area networks (WLAN). The Wi-Fi standards include 802.11, 802.11b, 802.11g, 802.11a, 802.11n, 802.11ac, 802.11ax. 802.11be is scheduled for release by the end of 2024, while 802.11bn is targeted for release in 2028. The waveform that is used till 802.11ax is orthogonal frequency division multiplexing (OFDM). Among the several features to be included in 802.11be, key features include support for 4096-QAM and 16 spatial streams and MIMO protocol enhancements. Recently a new waveform orthogonal time frequency space (OTFS) is proposed that exploits full channel diversity over time and frequency. This allows the OTFS modulation to significantly improve the performance. Due to backward compatibility with legacy OFDM systems, OTFS is implemented as a pre-processing stage to OFDM modulation.

Multiple input multiple output (MIMO) systems can transmit multiple parallel data streams for higher data rates. The standard uses convolutional codes for forward error correction as minimum requirement. LDPC codes are optional within the standard till 802.11ax but are mandatory from 802.11be for devices supporting higher bandwidths (greater than 20 MHz). The following prior arts on the existing Wi-Fi WLAN and OTFS may be considered

Ramjee Prasad, OFDM for Wireless Communications Systems, Artech, 2004. Provides a detailed description of OFDM waveform generation.

Suvra Sekhar Das & Ramjee Prasad, Orthogonal Time Frequency Space Modulation: OTFS a waveform for 6G, River Publishers, 2021 Provides a detailed description of OTFS waveform generation.

IEEE 802.11ax (Wi-Fi 6), 2021 Provides a detailed description of the Wi-Fi 6 standard.

US patent No: U.S. Pat. No. 11,283,561B2, Mar. 22, 2022 Provides the method of modulation of data part of Wi-Fi signal using OTFS modulation. Only convolutional encoding is considered.

B. V. Sudhakar Reddy et. al “A MIMO receiver using time frequency channel estimates for next generation wireless communication systems” co-pending Indian Patent Application number 202431059715 reports a generic receiver configuration that supports LDPC, multi-stream OTFS Transmission.

Traversing the prior arts, it was learned that very limited works have been reported which provides any Wi-Fi standard WLAN transmission methodology supporting OTFS modulation, LDPC codes and multi stream transmission for WLAN systems.

### OBJECTIVES OF THE INVENTION

Primary objective of the present invention is to develop new transmission methodology for supporting OTFS modulation and LDPC coded multi stream transmission for WLAN systems.

Yet another objective of the present invention is to develop a communication system involving transmitter supporting OTFS modulation and multi-stream transmission with LDPC coding for WLAN and receiver compatible to transmission methodology of the transmitter.

Yet another objective of the present invention is to develop a Multi-Input Multi-Output (MIMO) communication system involving transmitter supporting OTFS modulation and multi-stream transmission with LDPC coding for WLAN and receiver compatible to transmission methodology of the transmitter.

### SUMMARY OF THE INVENTION

Thus, according to the basic aspect of the present invention there is provided a Orthogonal Time Frequency Space (OTFS) based communication system for Wireless Local Area Network (WLAN) involving Multiple Input Multiple Output (MIMO) channels comprising
a transmitter including FEC (Forward Error Correction) encoder for input bit stream appended with pre-FEC bit sequence and transmission of LDPC encoded input data stream adapted for OTFS demodulation with the compatible receiver through multiple antennas with (Multiple Input Multiple Output) MIMO pre-coding;
signal processor means including OTFS modulators; and
a receiver with multiple antennas compatible to said transmitter and signal processor means for said OTFS waveform based transmission and retrieving of the input data stream.

In the above system, the transmitter includes
at least an FEC encoder unit to encode input data stream into a code block;
at least a signal processor for processing the code block and obtaining corresponding QAM/PSK symbol for including in a data vector of a length K; and
at least a MIMO pre-coding block based OTFS modulator having an inverse symplectic fast Fourier transform (ISFFT) based OTFS modulator for OTFS modulation of the data vector, and
at least a MIMO pre-coding block for pre-coding output of the ISFFT and mapping input samples of said MIMO pre-coding block to antennas of the transmitter involving OFDM modular associated at output of the MIMO pre-coding block to generate time domain OTFS symbol, whereby said OTFS symbol is passed to a digital to analogue (D/A) converter and Radio Frequency (RF) chain for transmission at mapped antenna.

In the above system, the input encoder unit operate as LDPC encoders whereby the input data stream is passed through prepender/appender sub-block where the input data stream is prepended with service bits, appended with pre-FEC bits that is then scrambled in scrambler sub-block followed by FEC encoding in FEC encoder giving encoded code blocks CB₁, CB₂, CB₃ . . . CBₚ as outputs which are divided across spatial streams for transmitting to said signal processors for power scaling.

In the above system, the signal processors for power scaling each includes code block assembly/arrangement with assembly or arrangement logic suiting compatible receiver and signal processing sequence based on including bit interleaver, symbol mapper, appender for appending post FEC symbols, symbol interleaver, power scalar, as sub-blocks favouring power scaled signal tones loaded with quadrature amplitude modulation (QAM) or phase shift keying (PSK) symbols as output for transmitting to said MIMO pre-precoding block based OTFS modulators in connection.

In the above system, the MIMO pre-coding block based OTFS modulator in connection receives parallel data stream based signal tones loaded with the quadrature amplitude modulation (QAM) or phase shift keying (PSK) symbols being included in a vector (dₚ) with the length of K for processing by inverse symplectic fast Fourier transform (ISFFT) sub-block for OTFS modulation as

$${x}_{p} = ( {F}_{N}^{H} ⊗ {F}_{M} ) {d}_{p} , \qquad ( 1 )$$

where

$${F}_{N}^{H}$$

is an inverse discrete Fourier transform (IDFT) matrix of order N and F_{M} is a DFT matrix of order M with parameters M and N are computed OTFS grid parameters and their product MN=K,
wherein for each k^{th} tone, the input to the MIMO pre-coding block is expressed in terms of the OTFS samples xₚ=[xₚ(1), xₚ(2), . . . , xₚ(k), . . . xₚ(K)]^{T}, as

$$x ( k ) = {[ \begin{matrix}{x}_{1} ( k ) \\ {x}_{2} ( k ) \\ ⋮ \\ {x}_{p} ( k ) \\ ⋮ \\ {x}_{p} ( k )\end{matrix} ]}_{p \times 1} \qquad ( 2 )$$

wherein said MIMO pre-coding block maps the P input samples to T antennas and places data samples onto data subcarriers of N_{ofps} OFDM symbols at each antenna and wherein pilot symbols also undergo MIMO pre-coding separately and are mapped to antennas, where they are placed onto the pilot subcarriers, wherein said inverse fast Fourier transform (IFFT) operation is involved for generating each time domain OTFS symbol by OFDM modulator followed by adding cyclic prefix (CP) whereby N_{ofps} OTFS symbols are thereafter passed to the digital to analogue (D/A) converter and Radio Frequency (RF) chain for transmission at each antenna wherein T antennas transmit T time domain signals, s₁, s₂, . . . , s_{T}.

In the above system, required conditional computation at transmitter for transmission includes:
computing requirement of select number of Code Blocks (nCB) for encoding based on input data bit stream characteristics as per below:
   a. PSDU (Physical layer conformance procedure (PLCP) service data unit) length L_{psdu} in Bytes which is first determined w.r.t to APEP length,
   b. No. of Payload bits (N_{payloadbits}) which is calculated by considering the service bits (N_{servbits}),

$${N}_{payloadbits} = {L}_{psdu} \times 8 + {N}_{servbits} ,$$

c. Number of information bits (k) per code block (CB) are calculated as k=R*L_{ldpc} where R is the code rate and L_{ldpc} is the length of LDPC code blocks,
d. Number of code blocks are then calculated as

$${N}_{cb} - ⌈ \frac{{N}_{payloadbits}}{k} ⌉$$

Where Π represents ceil operation,
e. in case the number of transmit streams (nₛₛ) are greater than 1 then the number of code blocks in the previous step are refined as

$${N}_{cb} = ⌈ \frac{{N}_{cb}}{{n}_{ss}} ⌉ * {n}_{ss} ;$$

computing code block assembly as per code block map for multi-antenna transmission and reception of parallel data stream

TABLE 3
Codeblock Map

| | | | | |
|---|---|---|---|---|
| stream 1 | 1 | 1 | 1 | 1 |
| stream 2 | 1 | 1\| | 1 | 0 |
| stream 3 | 1 | 1 | 1 | 0 |
| stream 4 | 1 | 1 | 1 | 0 |

wherein (a) in case of single transmit stream transmission no special arrangement of code blocks is required before feeding into LDPC encoder, (b) in case the number of transmit streams are greater than 1, then integer number of code blocks are transmitted per stream before feeding into LDPC encoder, (c) as a result code block arrangement is done as below
Step 1: calculating minimum integer no. of code blocks that can be transmitted per stream (q)

$$q = ⌊ \frac{{N}_{cb}}{{n}_{ss}} ⌋$$

where └ ┘ indicates the floor operation
Step 2: calculating the remaining code blocks to be transmitted (r)
r=N_{cb}%nₛₛ (% is the modulo operation providing remainder after dividing N_{cb} with nₛₛ)
Step 3: remaining ‘r’ code blocks which will be less than no. of streams (nₛₛ), where the division of codeblocks is made such that each stream carries one code block starting from first stream, calculating the no. of code blocks to be transmitted per stream (N_{cbps})
N_{cbps}=q×ones (1, nₛₛ)+[ones (1, r), zeros (1, nₛₛ−r)] where ones (1, r) create a row vector of 1's of size r & zeros (1, nₛₛ−r) creates a zero vector of zeros with size nₛₛ−r. N_{cbps} will be of size 1×nₛₛ;
computing number of OFDM symbols N_{ofps} per stream ensuring any ordering of code blocks where integer no of code blocks are loaded per stream. Example arrangements are shown in tables below

| | | | | |
|---|---|---|---|---|
| Stream1 | CB1 | CB2 | CB3 | |
| Stream2 | CB4 | CB5 | CB6 | CB7 |
| Stream3 | CB8 | CB9 | CB10 | |
| Stream4 | CB11 | CB12 | CB13 | |
| Stream1 | CB1 | CB2 | CB3 | |
| Stream2 | CB4 | CB5 | CB6 | |
| Stream3 | CB7 | CB8 | CB9 | CB10 |
| Stream4 | CB11 | CB12 | CB13 | |
| Stream1 | CB1 | CB5 | CB9 | CB13 |
| Stream2 | CB2 | CB6 | CB10 | |
| Stream3 | CB3 | CB7 | CB11 | |
| Stream4 | CB4 | CB8 | CB12 | |

where number of OFDM symbols required for transmission per stream is calculated as

$${N}_{ofps} = ⌈ \frac{{N}_{cb} \times {L}_{ldpc}}{{n}_{sd} \times {n}_{ss} \times m} ⌉ ,$$

n_{sd} is the no. of data sub carriers, m is bits per QAM/PSK symbol, where No. of QAM/PSK symbols which can be transmitted per stream

$$( {N}_{qpps} ) {N}_{qpps} = {N}_{ofps} \times {n}_{sd} ;$$

computing OTFS grid size based on denoting by M, N as number of grid points on the delay dimension with N denoting number of grid points on the Doppler dimension whereby the value of N is within the range N1 to N2 by consideration of the following:
   (a) checking N_{qpps} to be exactly divisible with N2 (zero remainder),
   (b) If yes, fixing the N value to N2,
   (c) If no, the N value is decreased to N2−1 and repeating step (a) with N2−1,
   (d) continuing the operation until N=N1,
   (e) once N is fixed computing M as M=N_{qpps}/N;
computing number of Pre-FEC bits to be appended before FEC encoding is based on N_{prefecbits}=N_{cb}×L_{ldpc}×R−L_{psdu}×8−N_{servbits} free of the need of adding shorten bits before LDPC Encoding and also free of the need of puncturing after LDPC encoding;
computing number of Post-FEC bits is based on number of Post-FEC bits to be appended after FEC encoding per stream based on
   calculating no. of QAM/PSK Symbols to be transmitted per stream

$${n}_{qpps} = ⌈ \frac{{N}_{cbps} \times {L}_{ldpc}}{m} ⌉$$

calculating no. of Post-FEC Symbols per stream N_{postfecps}=N_{qpps}−n_{qpps},
where the total Post-FEC symbols are the sum of Post-FEC symbols per stream

$${N}_{postfec} = {\sum }_{i = 1}^{{n}_{ss}} {N}_{postfecps} ( j )$$

and post-FEC symbols are populated with zeros in our transmission;
computing for power scaling is based on consideration that when N_{postfec} are non-zero, the non-zero QAM/PSK symbols in each stream are power boosted MN/n_{qpps}

In the above system, OTFS grid size of said transmitter is tuned to the number of symbols to be transmitted.

In the above system, number of Pre-FEC bits to be appended in the transmitter are computed in relation to number of code blocks, coderate, length of LDPC code block, data bits to be transmitted.

In the above system, in said transmitter, the number of Post-FEC bits to be appended are computed in relation to the number of QAM/PSK symbols that can be transmitted in respect of the actual number of QAM/PSK symbols transmitted, and, wherein the Post-FEC QAM/PSK symbols are made zero, and, wherein the power of the valid QAM/BPSK symbols are boosted.

In the above system, the receiver includes
OFDM demodulator sub-blocks linked to receiver blocks that receives desired radiofrequency (RF) for baseband conversion based on time and frequency synchronization circuitry;
receive antennas for processing the received signals y₁, y₂, . . . , yᵣ, . . . , y_{R} that undergo conversion from Radio Frequency (RF) to baseband, and are synchronized in time and frequency domain whereby for each r^{th} receive antenna, after RF to baseband conversion and synchronization, OFDM demodulation is performed on the frame of (N_{ofps}) OTFS symbols based on fast Fourier transform (FFT) processing and removal of the Cyclic Prefix (CP) for each OTFS symbol for said RF to baseband conversion and time and frequency synchronization circuitry whereby post OFDM demodulation for a specific k^{th} tone, the output from R receive antennas is represented in vector form as

$$y ( k ) = {[ \begin{matrix}{y}_{1} ( k ) \\ {y}_{2} ( k ) \\ ⋮ \\ {y}_{r} ( k ) \\ ⋮ \\ ⋮ \\ {y}_{R} ( k )\end{matrix} ]}_{R \times 1}$$

where yᵣ(k) is the output for k^{th} tone from r^{th} receive antenna.

In the above system, the received y^{th} radiofrequency (RF) signals at r^{th} receive antenna for k^{th} tone undergoes baseband conversion based on time and frequency synchronization circuitry as a part of MIMO-OTFS receiver architectural block for signal decoding using a iterative receiver where in the sub-blocks of Minimum mean square error (MMSE) based channel equalisation, symplectic fast Fourier transform (SFFT), soft demodulator, de-interleaver, FEC decoder are performed in the forward path and the decoded bits are used for reconstruction—for circulating the forwarded path output in a closed loop having sub-blocks of interleaver, soft modulator, inverse symplectic fast Fourier transform (ISFFT).

In the above system, the closed loop signal circulation includes H which is the estimated channel matrix.

In the above system, the MIMO-OTFS receiver architectural block includes Additional Signal Processing blocks (ASP1) and (ASP2) in the forward path of signal transmission and signal reconstruction path, wherein
said ASP1 block includes for processing each symplectic fast Fourier transform (SFFT) output stream, sub-blocks of power descaling and symbol de-interleaver for signal decoding, and
said ASP2 block includes for processing each soft modulator output stream sub-blocks of Symbol interleaver and power scalar for input to inverse symplectic fast Fourier transform (ISFFT) sub-block to facilitate signal reconstruction.

In the above system, for power scaling/descaling at the receiver architecture when N_{postfec} is a non-zero positive number, the non-zero QAM/PSK symbols in each stream are power descaled by n_{qpps}/(MN) in the forward path and boosted based on MN/n_{qpps} in the reconstruction path.

In the above system, at the receiver architecture end once the codeblocks are decoded correctly or maximum number of receiver iterations are reached at the receiver, data bits bCB1, bCB2 . . . bCBp are extracted as decoded bits from each code block that are appended enabling decoded data bit stream by involving sub-blocks including appender, de-scrambler, discarder that discards service bits and discards pre-FEC bits.

### BRIEF DESCRIPTION OF THE ACCOMPANYING DRAWINGS

FIG. 1: Transmitter Blocks till FEC Encoder.

FIG. 2: Transmitter Blocks from output of FEC Encoder till power scaling.

FIG. 3: OTFS Modulator

FIG. 4: Receiver Architecture

FIG. 5: MIMO-OTFS receiver as in prior Art [5]

FIG. 6: Additional Signal Processing (ASP1) Blocks

FIG. 7: Additional Signal Processing (ASP2) Blocks

FIG. 8: Decoded data stream

FIG. 9: FER performance of the invented WLAN Transmitter and Receiver for different configurations T(Transmit Antennas)*R(Receive Antennas)

### DETAILED DESCRIPTION OF THE INVENTION WITH REFERENCE TO THE ACCOMPANYING FIGURES

The Physical Layer (PHY) frame structure of WLAN 802.11ax standard has preamble, header and data fields. The preamble is used for time and frequency synchronization at the receiver. The header carries essential control information, including the data transmission rate and the payload length. The payload carries the actual data being transmitted.

In OFDM transmissions each data subcarrier is regarded as one tone. These tones are loaded with quadrature amplitude modulation (QAM) or phase shift keying (PSK) symbols.

In a MIMO system, which includes multi-antenna transmission and reception, P data symbols are transmitted over each tone. Here, P represents the number of parallel data streams. MIMO pre-coding is used to match the P streams to T antennas. There are two types of MIMO systems based on codebook selection
1. open loop
2. closed loop

In closed-loop systems, codebooks utilized for MIMO pre-coding, ensure that P≤T. The codebook selection depends on the channel state information (CSI) fed back from the receiver.

In open-loop MIMO, the number of streams, P is equal to the number of transmit antennas, denoted as T.

In OTFS, the inverse symplectic fast Fourier transform (ISFFT) is performed on the data symbols before loading onto the tones.

### Transmitter

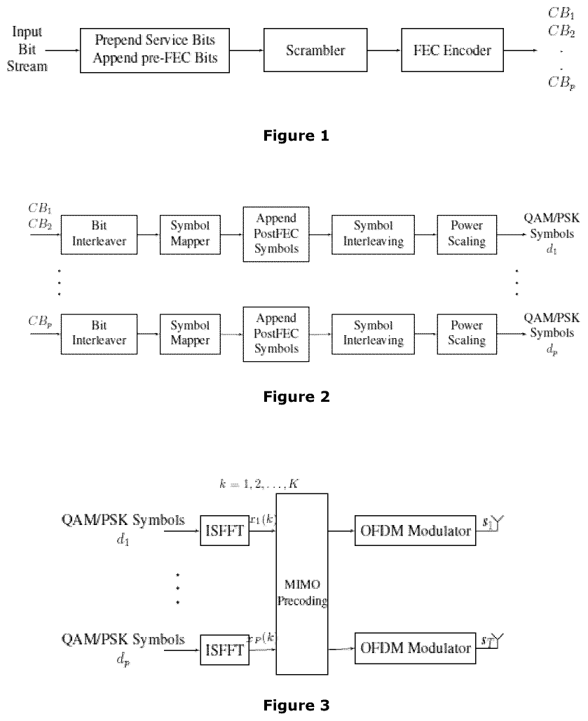

The transmission methodology involving OTFS waveform, LDPC encoding and MIMO are outlined in FIGS. 1, 2, 3.

An input encoder unit of the transmitter is shown in the FIG. 1. In this input encoder unit, input data stream is encoded into a code block. Herein, the input data stream is prepended with service bits. Pre-FEC bits are appended. The bit sequence is then scrambled and FEC encoded. The outputs of such encoder units are the code blocks CB₁, CB₂, CB₃ . . . CBₚ.

The encoded code blocks are divided across spatial streams as per the code block arrangement logic outlined in the later part of the document. Once the code blocks are arranged, the sequence of signal processing steps are performed on the code blocks by the signal processors of the transmitter as per FIG. 2. The signal processors finally produce QAM/PSK symbols from the code blocks.

These QAM/PSK symbols are included in data vectors d₁ . . . , dₚ each with a length of K and these vectors applied to inverse symplectic fast Fourier transform (ISFFT) whose output is

$${x}_{p} = \{ {F}_{N}^{B} ⊗ {F}_{M} \} {d}_{p} , \qquad ( 1 )$$

where

$${F}_{N}^{B}$$

is an inverse discrete Fourier transform (IDFT) matrix of order N and F_{M} is a DFT matrix of order M. The parameters M and N are grid parameters and their product MN=K. The calculation of OTFS grid parameters (M & N) is outlined in the later part of the document.

For each k^{th} tone, the outputs of the ISFFT are inputted to a MIMO pre-coding block of the transmitter.

This is expressed in terms of the OTFS samples as follows:

$${x}_{p} = {[ {x}_{p} ( 1 ) , {x}_{p} ( 2 ) , … , {x}_{p} ( k ) , … {x}_{P} ( K ) ]}^{T} , and$$

$$x ( k ) = {[ \begin{matrix}{x}_{1} ( k ) \\ {x}_{2} ( k ) \\ ⋮ \\ {x}_{p} ( k ) \\ ⋮ \\ {x}_{P} ( k )\end{matrix} ]}_{P \times 1} \qquad ( 2 )$$

The MIMO pre-coding block maps the P input samples to T antennas of the transmitter. These samples are then placed onto the data subcarriers of N_{ofps} OFDM symbols at each antenna. Pilot symbols also undergo MIMO pre-coding separately and are mapped to antennas, where they are placed onto the pilot subcarriers. The inverse fast Fourier transform (IFFT) operation is used to generate time domain OTFS Symbol in the OFDM modulars associated at outputs of the MIMO pre-coding block. A cyclic prefix (CP) is then added and the N_{ofps} OTFS symbols are passed to the digital to analogue (D/A)(/) converter and Radio Frequency (RF) chain for transmission at each antenna. T antennas transmit T time domain signals, s₁, s₂, . . . , s_{T}, as shown in FIG. 3. A/D converter and RF chain are not shown in the figure for ease of representation.

Required computations while employing the transmission methodology are outlined below:

### 1. Calculation of Number of Code Blocks (N_{cb}):

1. PSDU (Physical layer conformance procedure (PLCP) service data unit) length L_{psdu} in Bytes is first determined w.r.t to APEP length
2. No. of Payload bits (N_{payloadbits}) is calculated by considering the service bits (N_{servbits})

$${N}_{payloadbits} = {L}_{psdu} \times 8 + {N}_{servbits}$$

3. The number of information bits (k) per code block (CB) are calculated as k=R*L_{ldpc} where R is the code rate and L_{ldpc} is the length of LDPC code blocks.
4. The number of code blocks are then calculated as

$${N}_{cb} = ⌈ \frac{{N}_{payloadbits}}{k} ⌉$$

Where Π represents ceil operation.
5. In case the number of transmit streams (nₛₛ) are greater than 1 then the number of code blocks in the previous step are refined as

$${N}_{cb} = ⌈ \frac{{N}_{cb}}{{n}_{ss}} ⌉ * {n}_{ss}$$

### 2. Code Block Arrangement:

TABLE 3
Codeblock Map

| | | | | |
|---|---|---|---|---|
| stream 1 | 1 | 1 | 1 | 1 |
| stream 2 | 1 | 1\| | 1 | 0 |
| stream 3 | 1 | 1 | 1 | 0 |
| stream 4 | 1 | 1 | 1 | 0 |

(a) In case of single transmit stream transmission no special arrangement of code blocks is required before feeding into LDPC encoder.
(b) In case the number of transmit streams are greater than 1, then integer number of code blocks are transmitted per stream before feeding into LDPC encoder.
(c) As a result, code block arrangement has to be done. The code block arrangement per stream is as below
Step 1: Calculate minimum integer no. of code blocks that can be transmitted per stream (q)

$$q = ⌊ \frac{{N}_{cb}}{{n}_{ss}} ⌋$$

Where └ ┘ indicates the floor operation
Step 2: Calculate the remaining code blocks to be transmitted (r)
r=N_{cb}%nₛₛ (% is the modulo operation providing remainder after dividing N_{cb} with nₛₛ)
Step 3: These remaining ‘r’ code blocks will be less than no. of streams (nₛₛ).

The division of codeblocks is made such that each stream carries one code block starting from first stream.

Calculate the no. of code blocks to be transmitted per stream (N_{cbps})

N_{cbps}=q×ones (1, nₛₛ)+[ones (1, r), zeros (1, nₛₛ−r)] where ones (1, r) create a row vector of 1's of size r & zeros (1, nₛₛ−r) creates a zero vector of zeros with size nₛₛ−r. N_{cbps} will be of size 1×nₛₛ.

A sample calculation employing N_{cb}=13 and 4 stream (nₛₛ) transmission is outlined below.

q=q=└13/4┘=3; r=(13%4)=1; so, each stream will carry 3 code blocks. CB map is created as illustrated in Table 3. Code block arrangement as per CB map is shown in Table 4.

### 3. Calculation of Number of OFDM Symbols (N_{ofps}) Per Stream

The number of OFDM symbols required for transmission per stream is calculated as

$${N}_{ofps} = ⌈ \frac{{N}_{cb} \times {L}_{ldpc}}{{n}_{sd} \times {n}_{ss} \times m} ⌉ ,$$

n_{sd} is the no. of data sub carriers, m is bits per QAM/PSK symbol. No. of QAM/PSK symbols which can be transmitted per stream (N_{qpps})

$${N}_{qpps} = {N}_{ofps} \times {n}_{sd}$$

### 4. Calculation of OTFS Grid Size

Let M, N denote the number of grid points on the delay dimension and N denote the number of grid points on the Doppler dimension. We find the value of N within range N1 to N2 with the following process:
(a) We check if N_{qpps} is exactly divisible with N2 (zero remainder)
(b) If yes, we fix the N value to N2
(c) If no, we decrease the N value to N2−1 and repeat step (a) with N2−1
(d) We continue this process until N=N1
(e) Once N is fixed, we calculate M as

$$M = \frac{{N}_{qpps}}{N}$$

### 5. Calculation of Number of Pre-FEC Bits

The number of Pre-FEC bits to be appended before FEC encoding is calculated as

$${N}_{prefecbits} = {N}_{cb} \times {L}_{ldpc} \times R - {L}_{psdu} \times 8 - {N}_{servbits}$$

There is no need of adding shorten bits before LDPC Encoding with such calculation. There is also no need of puncturing after LDPC Encoding.

### 6. Calculation of Number of Post-FEC Symbols Per Stream (N_{postfecps})

Calculate no. of QAM/PSK Symbols to be transmitted per stream

$${n}_{qpps} = ⌈ \frac{{N}_{cbps} \times {L}_{ldpc}}{m} ⌉$$

Calculate no. of Post-FEC Symbols per stream N_{postfecps}=N_{qpps}−n_{qpps} The total Post-FEC symbols are the sum of Post-FEC symbols per stream

$${N}_{postfec} = {\sum }_{j = 1}^{{n}_{ss}} {N}_{postfecps} ( j )$$

Post-FEC symbols are populated with zeros in our transmission.

### 7. Power Scaling

In cases where the N_{postfec} is a non-zero number, the non-zero QAM/PSK symbols in each stream are power boosted by

$$\frac{MN}{{n}_{qpps}}$$

### Receiver Architecture

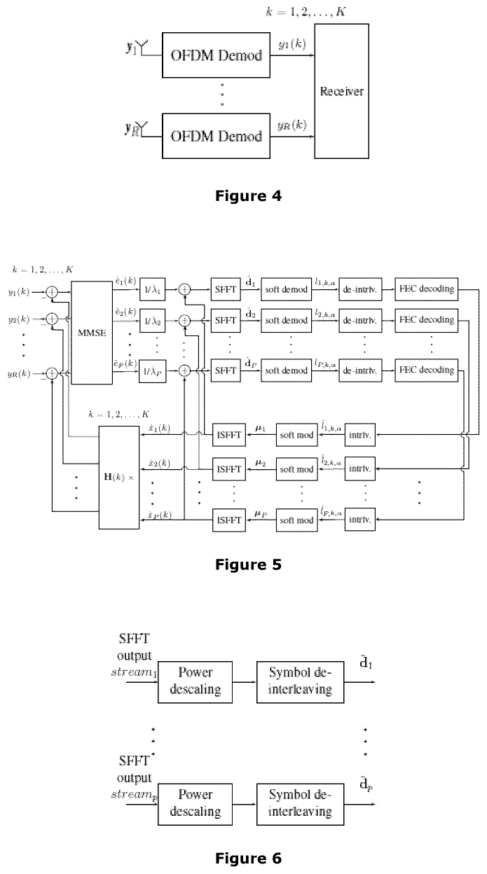

At the receiver, with R receive antennas, the received signals y₁, y₂, . . . , yᵣ, . . . , y_{R} undergo conversion from Radio Frequency (RF) to baseband, and are synchronized in time and frequency. For each r^{th} receive antenna, after RF to baseband conversion and synchronization, OFDM demodulation is performed on the frame of N_{ofps} OTFS symbols. This process includes the fast Fourier transform (FFT) and removal of the Cyclic Prefix (CP) for each OTFS symbol. The RF to baseband conversion and time and frequency synchronization circuitry are omitted in FIG. 4. After OFDM demodulation, for a specific k^{th} tone, the output from R receive antennas is represented in vector form as

$$y ( k ) = {[ \begin{matrix}{y}_{1} ( k ) \\ {y}_{2} ( k ) \\ ⋮ \\ {y}_{r} ( k ) \\ ⋮ \\ ⋮ \\ {y}_{R} ( k )\end{matrix} ]}_{Rx 1} \qquad ( 3 )$$

where yᵣ(k) is the output for k^{th} tone from r^{th} receive antenna.

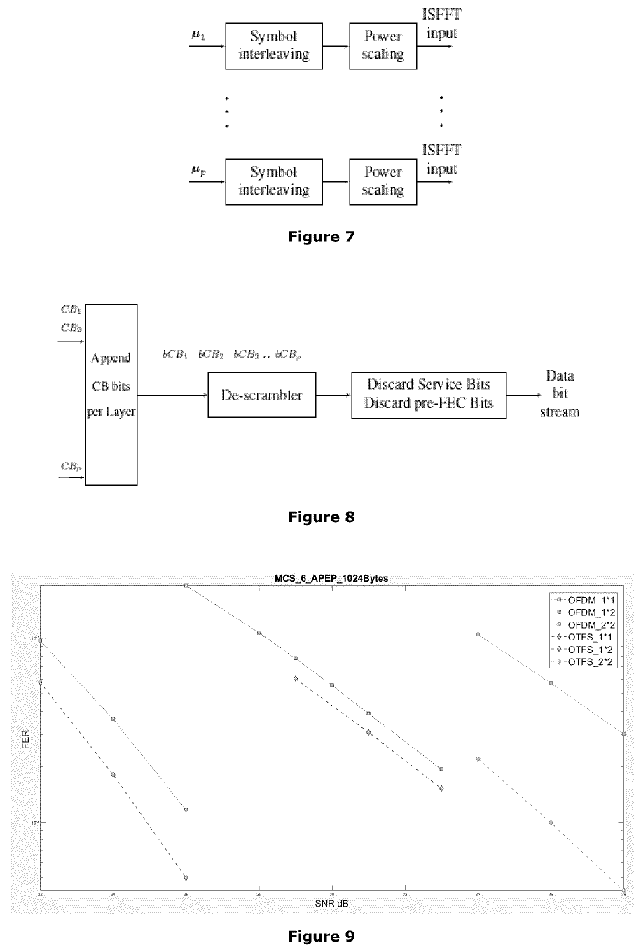

Additional Signal Processing needs to be performed in the forward path and the reconstruction path for the invented receiver in [5] to make compatible to the invented transmission scheme. The required signal processing blocks are specified in FIG. 6 for the forward path and FIG. 7 in the reconstruction path.

In cases where the N_{postfec} is a non-zero positive number, the non-zero QAM/PSK symbols in each stream are power descaled by n_{qpps}/(MN) in the forward path and boosted as earlier in the reconstruction path.

Once the codeblocks are decoded correctly or maximum receiver iterations are reached for the receiver in FIG. 5 the data bits are extracted as specified in FIG. 8. bCB₁, bCB₂ . . . bCBₚ are the decoded bits from each code block which are appended.

### Performance Evaluation:

The simulation parameters are given in Table 5 for testing the invented MIMO-OTFS transmission scheme and the corresponding reception mechanism.

FIG. 9 shows the Frame Error Rate (FER) for different P transmissions, using non-code book identity matrix pre-coding. We observe better error performance when compared to existing OFDM based Wi-Fi Transmission. We also observe improved error performance with diversity and spatial multiplexing with our invented transmission and reception methods.

TABLE 5
Simulation Parameters

| Carrier frequency | 5 | GHz |
|---|---|---|
| Channel | TGax, Model-B | |
| Velocity | 5 | kmph |
| Modulation | 64 QAM | |
| FEC coding | LDPC | |
| Codeblock length | 1944 | |
| APEP length | 1024 | Bytes |

| | |
|---|---|
| Code rate | 3/4 |
| Max. number of receiver iterations | 10 |

Thus, the salient features of the invention is enumerated as follows:
1. A transmitter architecture for an Orthogonal Time Frequency Space (OTFS) waveform with Multiple Input Multiple Output (MIMO) configuration for existing (802.11ax) and future Wi-Fi systems. (802.11be and 802.11bn).
2. The transmitter architecture where LDPC encoding is supported.
3. The transmitter architecture where number of puncture bits and shortening bits are zero.
4. The transmitter architecture where new method of calculation of number of code blocks based on APEP length (Aggregate MAC protocol data unit (A-MPDU) pre-EOF padding), code rate, length of LDPC code blocks and number of streams.
5. The transmitter architecture where code blocks arrangement stream wise is done so that full and integer number of code blocks are transmitted per stream.
6. The transmitter architecture where number of OFDM Symbols per stream are calculated to accommodate the number of symbols to be transmitted per stream.
7. The transmitter architecture where OTFS grid size is made tunable with the number of symbols to be transmitted.
8. The transmitter architecture where the number of Pre-FEC bits to be appended are calculated in relation to the number of code blocks, code rate, length of LDPC code block, data bits to be transmitted.
9. The transmitter architecture where the number of Post-FEC bits to be appended are calculated in relation to the number of QAM/PSK symbols that can be transmitted to the actual number of QAM/PSK symbols transmitted.
10. The transmitter architecture in claim 1 where the Post-FEC QAM/PSK symbols are made zero.
11. The transmitter architecture where the power of the valid QAM/BPSK symbols is boosted.
12. A receiver architecture which corresponds to the transmission methodology.
13. Receiver architecture where in power descaling and symbol de-interleaving is performed.

### Advantages

1. Introduces a new method of code block calculation when multi-stream transmission is involved.
2. Introduces a new method of required OFDM symbol calculation for multi stream transmission.
3. Introduces a new method of code block arrangement for multi stream transmission with LDPC encoding.
4. Introduces a new method of sending QAM/PSK symbols of zero value for Post-FEC symbols.

### Applications

1. This invention introduces OTFS waveform based multi stream transmission with LDPC support into WLAN 802.11ax paving way for its inclusion in future Wi-Fi standards.

1. An Orthogonal Time Frequency Space (OTFS) based communication system for Wireless Local Area Network (WLAN) involving Multiple Input Multiple Output (MIMO) channels comprising
a transmitter including FEC (Forward Error Correction) encoder for input bit stream appended with pre-FEC bit sequence and transmission of LDPC encoded input data stream adapted for OTFS demodulation with the compatible receiver through multiple antennas with (Multiple Input Multiple Output) MIMO pre-coding;
signal processor means including OTFS modulators; and
a receiver with multiple antennas compatible to said transmitter and signal processor means for said OTFS waveform based transmission and retrieving of the input data stream.

2. The system as claimed in claim 1, wherein the transmitter includes
at least an FEC encoder unit to encode input data stream into a code block;
at least a signal processor for processing the code block and obtaining corresponding QAM/PSK symbol for including in a data vector of a length K; and
at least a MIMO pre-coding block based OTFS modulator having an inverse symplectic fast Fourier transform (ISFFT) based OTFS modulator for OTFS modulation of the data vector, and
at least a MIMO pre-coding block for pre-coding output of the OTFS modulator and mapping input samples of said MIMO pre-coding block to antennas of the transmitter involving OFDM modular associated at output of the MIMO pre-coding block to generate time domain OTFS symbol, whereby said OTFS symbol is passed to a digital to analogue (D/A) converter and Radio Frequency (RF) chain for transmission at mapped antenna.

3. The system as claimed in claim 2, wherein the encoder unit operate as LDPC encoders whereby the input data stream is passed through prepender/appender sub-block where the input data stream is prepended with service bits, appended with pre-FEC bits that is then scrambled in scrambler sub-block followed by FEC encoding in FEC encoder giving encoded code blocks CB₁, CB₂, CB₃ . . . CBₚ as outputs which are divided across spatial streams for transmitting to said signal processors for power scaling.

4. The system as claimed in claim 2, wherein said signal processors for power scaling each includes code block assembly/arrangement with assembly or arrangement logic suiting compatible receiver and signal processing sequence based on including bit interleaver, symbol mapper, appender for appending post FEC symbols, symbol interleaver, power scalar, as sub-blocks favouring power scaled signal tones loaded with quadrature amplitude modulation (QAM) or phase shift keying (PSK) symbols as output for transmitting to said MIMO pre-precoding block based OTFS modulators in connection.

5. The system as claimed in claim 2, wherein said MIMO pre-coding block based OTFS modulator in connection receives parallel data stream based signal tones loaded with the quadrature amplitude modulation (QAM) or phase shift keying (PSK) symbols being included in a vector (dₚ) with the length of K for processing by inverse symplectic fast Fourier transform (ISFFT) sub-block for OTFS modulation as
$${x}_{p} = ( F \text{?} ⊗ {F}_{M} ) {d}_{p} , \qquad ( 1 )$$
$$\text{?} \text{indicates text missing or illegible when filed}$$
where
$$F \text{?}$$
$$\text{?} \text{indicates text missing or illegible when filed}$$
is an inverse discrete Fourier transform (IDFT) matrix of order N and F_{M} is a DFT matrix of order M with parameters M and N are computed OTFS grid parameters and their product MN=K,
wherein for each k^{th} tone, the input to the MIMO pre-coding block is expressed in terms of the OTFS samples xₚ=[xₚ(1), xₚ(2), . . . , xₚ(k), . . . xₚ(K)]^{T}, as
$$x ( k ) = [ \begin{matrix}{x}_{1} ( k ) \\ {x}_{2} ( k ) \\ ⋮ \\ {x}_{p} ( k ) \\ ⋮ \\ x \text{?} ( k )\end{matrix} ] \text{?} \qquad ( 2 )$$
$$\text{?} \text{indicates text missing or illegible when filed}$$
wherein said MIMO pre-coding block maps the P input samples to T antennas and places data samples onto data subcarriers of N_{ofps} OFDM symbols at each antenna and wherein pilot symbols also undergo MIMO pre-coding separately and are mapped to antennas, where they are placed onto the pilot subcarriers,
wherein said inverse fast Fourier transform (IFFT) operation is involved for generating each time domain OTFS symbol by OFDM modulator followed by adding cyclic prefix (CP) whereby N_{ofps} OTFS symbols are thereafter passed to the digital to analogue (D/A) converter and Radio Frequency (RF) chain for transmission at each antenna wherein T antennas transmit T time domain signals, s₁, s₂, . . . , s_{T}.

6. The system as claimed in claim 1, wherein required conditional computation at transmitter for transmission includes:
computing requirement of select number of Code Blocks (nCB) for encoding based on input data bit stream characteristics as per below:
a. PSDU (Physical layer conformance procedure (PLCP) service data unit) length L_{psdu} in Bytes which is first determined w.r.t to APEP length,
b. No. of Payload bits (N_{payloadbits}) which is calculated by considering the service bits (N_{servbits}),
$${N}_{payloadbits} = {L}_{psdu} \times 8 + {N}_{servbits} ,$$
c. Number of information bits (k) per code block (CB) are calculated as k=R*L_{ldpc} where R is the code rate and L_{ldpc} is the length of LDPC code blocks,
d. Number of code blocks are then calculated as
$${N}_{cb} = ⌈ \frac{{N}_{payloadbits}}{k} ⌉$$
Where Π represents ceil operation,
e. in case the number of transmit streams (nₛₛ) are greater than 1 then the number of code blocks in the previous step are refined as
$${N}_{cb} = ⌈ \frac{{N}_{cb}}{{n}_{ss}} ⌉ *$$
nₛₛ;
computing code block assembly as per code block map for multi-antenna transmission and reception of parallel data stream
TABLE 3
Codeblock Map

| | | | | |
|---|---|---|---|---|
| stream 1 | 1 | 1 | 1 | 1 |
| stream 2 | 1 | 1\| | 1 | 0 |
| stream 3 | 1 | 1 | 1 | 0 |
| stream 4 | 1 | 1 | 1 | 0 |

wherein (a) in case of single transmit stream transmission no special arrangement of code blocks is required before feeding into LDPC encoder, (b) in case the number of transmit streams are greater than 1, then integer number of code blocks are transmitted per stream before feeding into LDPC encoder, (c) as a result code block arrangement is done as below
Step 1: calculating minimum integer no. of code blocks that can be transmitted per stream (q)
$$q = ⌊ \frac{{N}_{cb}}{{n}_{ss}} ⌋$$
Where └ ┘ indicates the floor operation
Step 2: calculating the remaining code blocks to be transmitted (r)
r=N_{cb}%nₛₛ (% is the modulo operation providing remainder after dividing N_{cb} with nₛₛ)
Step 3: remaining ‘r’ code blocks which will be less than no. of streams (nₛₛ), where the division of codeblocks is made such that each stream carries one code block starting from first stream, calculating the no. of code blocks to be transmitted per stream (N_{cbps})
N_{cbps}=q×ones (1, nₛₛ)+[ones (1, r), zeros (1, nₛₛ−r)] where ones (1, r) create a row vector of 1's of size r & zeros (1, nₛₛ−r) creates a zero vector of zeros with size nₛₛ−r. N_{cbps} will be of size 1×nₛₛ;
computing number of OFDM symbols N_{ofps} per stream ensuring any ordering of code blocks where integer no of code blocks are loaded per stream. Example arrangements are shown in tables below

| | | | | |
|---|---|---|---|---|
| Stream1 | CB1 | CB2 | CB3 | |
| Stream2 | CB4 | CB5 | CB6 | CB7 |
| Stream3 | CB8 | CB9 | CB10 | |
| Stream4 | CB11 | CB12 | CB13 | |
| Stream1 | CB1 | CB2 | CB3 | |
| Stream2 | CB4 | CB5 | CB6 | |
| Stream3 | CB7 | CB8 | CB9 | CB10 |
| Stream4 | CB11 | CB12 | CB13 | |
| Stream1 | CB1 | CB5 | CB9 | CB13 |
| Stream2 | CB2 | CB6 | CB10 | |
| Stream3 | CB3 | CB7 | CB11 | |
| Stream4 | CB4 | CB8 | CB12 | |

where number of OFDM symbols required for transmission per stream is calculated as
$${N}_{ofps} = ⌈ \frac{{N}_{cb} \times {L}_{ldpc}}{{n}_{sd} \times {n}_{ss} \times m} ⌉ ,$$
n_{sd} is the no. of data sub carriers, m is bits per QAM/PSK symbol, where No. of OAM/PSK symbols which can be transmitted per stream
$$( {N}_{qpps} ) {N}_{qpps} = {N}_{ofps} \times {n}_{sd} ;$$
computing OTFS grid size based on denoting by M, N as number of grid points on the delay dimension with N denoting number of grid points on the Doppler dimension whereby the value of N is within the range N1 to N2 by consideration of the following:
(a) checking N_{qpps} to be exactly divisible with N2 (zero remainder),
(b) If yes, fixing the N value to N2,
(c) If no, the N value is decreased to N2−1 and repeating step (a) with N2−1,
(d) continuing the operation until N=N1,
(e) once N is fixed computing M as M=N_{qpps}/N;
computing number of Pre-FEC bits to be appended before FEC encoding is based on N_{prefecbits}=N_{cb}×L_{ldpc}×R−L_{psdu}×8−N_{servbits} free of the need of adding shorten bits before LDPC Encoding and also free of the need of puncturing after LDPC encoding;
computing number of Post-FEC bits is based on number of Post-FEC bits to be appended after FEC encoding per stream based on
calculating no. of QAM/PSK Symbols to be transmitted per stream
$${n}_{qpps} = ⌈ \frac{{N}_{cbps} \times {L}_{ldpc}}{m} ⌉$$
calculating no. of Post-FEC Symbols per stream N_{postfecps}=N_{qpps}−n_{qpps},
where the total Post-FEC symbols are the sum of Post-FEC symbols per stream
$${N}_{postfec} = {\sum }_{j = 1}^{{n}_{ss}} {N}_{postfecps} ( j )$$
and post-FEC symbols are populated with zeros in our transmission;
computing for power scaling is based on consideration that when N_{postfec} are non-zero, the non-zero QAM/PSK symbols in each stream are power boosted MN/n_{qpps}

7. The system as claimed in claim 6, wherein OTFS grid size of said transmitter is tuned to the number of symbols to be transmitted.

8. The system as claimed in claim 1, wherein number of Pre-FEC bits to be appended in the transmitter are computed in relation to number of code blocks, coderate, length of LDPC code block, data bits to be transmitted.

9. The system as claimed in claim 1, wherein in said transmitter, the number of Post-FEC bits to be appended are computed in relation to the number of QAM/PSK symbols that can be transmitted in respect of the actual number of QAM/PSK symbols transmitted, and, wherein the Post-FEC QAM/PSK symbols are made zero, and, wherein the power of the valid QAM/BPSK symbols are boosted.

10. The system as claimed in claim 9, wherein receiver includes OFDM demodulator sub-blocks linked to receiver blocks that receives desired radiofrequency (RF) for baseband conversion based on time and frequency synchronization circuitry;
receive antennas for processing the received signals y₁, y₂, . . . yᵣ, . . . y_{R} that undergo conversion from Radio Frequency (RF) to baseband, and are synchronized in time and frequency domain whereby for each r^{th} receive antenna, after RF to baseband conversion and synchronization, OFDM demodulation is performed on the frame of (N_{ofps}) OTFS symbols based on fast Fourier transform (FFT) processing and removal of the Cyclic Prefix (CP) for each OTFS symbol for said RF to baseband conversion and time and frequency synchronization circuitry whereby post OFDM demodulation for a specific k^{th} tone, the output from R receive antennas is represented in vector form as
$$y ( k ) = {[ \begin{matrix}{y}_{1} ( k ) \\ {y}_{2} ( k ) \\ ⋮ \\ {y}_{r} ( k ) \\ ⋮ \\ ⋮ \\ {y}_{R} ( k )\end{matrix} ]}_{Rx 1}$$
where yᵣ(k) is the output for k^{th} tone from r^{th} receive antenna.

11. The system as claimed in claim 10, wherein said received y^{th} radiofrequency (RF) signals at r^{th} receive antenna for k^{th} tone undergoes baseband conversion based on time and frequency synchronization circuitry as a part of MIMO-OTFS receiver architectural block for signal decoding using a iterative receiver where in the sub-blocks of Minimum mean square error (MMSE) based channel equalisation, symplectic fast Fourier transform (SFFT), soft demodulator, de-interleaver, FEC decoder are performed in the forward path and the decoded bits are used for reconstruction—for circulating the forwarded path output in a closed loop having sub-blocks of interleaver, soft modulator, inverse symplectic fast Fourier transform (ISFFT).

12. The system as claimed in claim 11, wherein said closed loop signal circulation includes H which is the estimated channel matrix.

13. The system as claimed in claim 10, wherein said MIMO-OTFS receiver architectural block includes Additional Signal Processing blocks (ASP1) and (ASP2) in the forward path of signal transmission and signal reconstruction path, wherein said ASP1 block includes for processing each symplectic fast Fourier transform (SFFT) output stream, sub-blocks of power descaling and symbol de-interleaver for signal decoding, and
said ASP2 block includes for processing each soft modulator output stream sub-blocks of Symbol interleaver and power scalar for input to inverse symplectic fast Fourier transform (ISFFT) sub-block to facilitate signal reconstruction.

14. The system as claimed in claim 3, wherein for power scaling/descaling at the receiver architecture when N_{postfec} is a non-zero positive number, the non-zero QAM/PSK symbols in each stream are power descaled by n_{qpps}/(MN) in the forward path and boosted based on MN/n_{qpps} in the reconstruction path.

15. The system as claimed in claim 1, wherein at the receiver architecture end once the codeblocks are decoded correctly or maximum number of receiver iterations are reached at the receiver, data bits bCB1, bCB2 . . . bCBp are extracted as decoded bits from each code block that are appended enabling decoded data bit stream by involving sub-blocks including appender, de-scrambler, discarder that discards service bits and discards pre-FEC bits.
